(19) United States
(12) Patent Application Publication
(10) Pub. No.: US 2021/0141241 A1
(43) Pub. Date: May 13, 2021

(54) DEVICE FOR THE DEMATERIALISED AERIAL PROJECTION OF A DIGITAL IMAGE OR A SEQUENCE OF DIGITAL IMAGES, IN PARTICULAR AN AUTO-STEREOSCOPIC IMAGE OR A SEQUENCE OF AUTOSTEREOSCOPIC IMAGES

(71) Applicant: ALIOSCOPY, Paris (FR)

(72) Inventor: Pierre ALLIO, Paris (FR)

(21) Appl. No.: 16/493,295

(22) PCT Filed: Mar. 12, 2018
(86) PCT No.: PCT/FR2018/050563

§ 371 Date: Sep. 11, 2019

(30) Foreign Application Priority Data
Mar. 17, 2017 (FR) 1752245

(51) Int. Cl. G02B 30/56; G02B 30/27; G02B 27/00; G02B 1/11; H04N 13/305; H04N 13/346

(52) U.S. Cl. CPC G02B 30/56; G02B 30/27; G02B 27/0093; H04N 13/346; G02B 1/11; H04N 13/305; G02B 27/0025

(57) ABSTRACT

The invention concerns a device for the dematerialised aerial projection of a digital image (31) comprising: a housing (10) in which an opening is provided forming a viewing window (15) for viewing a dematerialised aerial image (32) of said digital image (31); an optical system comprising at least one concave spherical mirror (24), said optical system being arranged in said housing (10) such that it can direct at least some of the received incident light towards said observation window (15) in order to form a dematerialised aerial image (32) of the digital image (31) there; a display screen (23) for displaying said digital image (31) to be projected, housed in said housing (10) facing said spherical mirror (24) at a distance equal to double the focal length of the spherical mirror, and separated from said optical axis (20) of said spherical mirror (24), perpendicularly to this optical axis (20), by a distance at least equal to half the height of the display screen (23).

### 1. TECHNICAL FIELD OF THE INVENTION

The invention relates to a device for the aerial and virtual projection of an image or sequence of images. The invention also relates to a device for the aerial and virtual projection of an autostereoscopic image or sequence of autostereoscopic images forming video content.

### 2. TECHNOLOGICAL BACKGROUND

A device for the aerial and virtual projection of an object is a device which makes it possible to project an image of the object in front of a window formed in a case and which gives the viewer the illusion of a three-dimensional object floating in space.

Such a device is known for projecting real objects. This device typically comprises a case (which may or may not be opaque), which has an opening intended to form a viewing window for the virtual image, an optical system, generally a Fresnel lens or a lens or set of lenses or a concave mirror, and an object arranged at a distance from the optical system which is configured to direct the image of the object towards the viewing window.

For example, U.S. Pat. No. 6,817,716 describes such a device comprising a lower compartment in which a real object is illuminated by a light source, an upper compartment comprising a viewing window formed on the front-facing side, a concave mirror and a semi-reflective plane mirror tilted 45 degrees on the optical axis of the concave mirror on which the viewing window is centered, with said semi-reflective mirror being arranged between the viewing window and the concave mirror to the right of the real object. Thus, the image of the object is partially reflected by the semi-reflective mirror tilted 45 degrees in the direction of the concave mirror, which returns the image to the semi-reflective mirror which allows part of the image to pass through to the viewing window. A viewer then has the impression of seeing the real object floating in front of the viewing window.

One of the problems with this solution is that if the real object is replaced by a digital image, part of the image reflected by the concave mirror is also reflected towards the source by the semi-reflective mirror. This returned image only rarely has an effect in the case of a real object because it is three-dimensional and upside down, such that it illuminates the returned object without altering its appearance and details. This is because the real object is a 3D object and is very brightly directly illuminated, which means that the reflected image is not very destructive. In other words, in the case of a real object, the returned image also constitutes (with rare exceptions, for example: a watch dial) additional illumination of the real object, which does not interfere with how the device operates. On the other hand, if a real object is replaced by a flat screen for displaying a digital image to be perceived at full scale, the returned image interferes with the source image because it is formed in exactly the same position and with maximum sharpness on the surface of said screen, such that the projected image is severely deteriorated. One possible solution to counter this phenomenon could be to bring the display screen for the digital image to be projected closer to the optical system to obtain a magnification effect of the projected image. This magnification is obtained because the image is projected further towards the viewer and therefore defocuses the returned image such that it is diffuse and therefore no longer interferes with the original image, which is no longer on the same plane but very far back. On the other hand, bringing the concave mirror closer to the display screen adversely affects the image quality by giving it a very rounded appearance linked to the conic perspective used, diverging significantly from the conditions for combining the object plane with the full-scale image plane.

The inventors have sought to improve the known devices and to adapt the aerial and virtual projection technique of a real object to digital images, especially to autostereoscopic images.

An autostereoscopic image consists of a plurality of nested elementary images, each corresponding to a different viewpoint of an object or a scene. Viewing an autostereoscopic image involves using a selective optical device, such as a cylindrical lens array, arranged in front of an autostereoscopic display screen.

This selective optical device makes it possible for a viewer's eyes to perceive just two respective elementary images corresponding to two different viewpoints, which gives an illusion of 3D stereoscopic volume both popping outwards and in terms of depth.

### 3. AIMS OF THE INVENTION

The invention aims to provide a device for the aerial and virtual projection of a digital image that overcomes at least some of the disadvantages of the known solutions.

The invention also aims to provide such a device adapted to an autostereoscopic image or sequence of autostereoscopic images.

The invention also aims to provide, in at least one embodiment, a device for the aerial and virtual projection of a digital image, in particular autostereoscopic image, which improves the visual comfort for a viewer.

The invention also aims to provide, in at least one embodiment, a compact device for the aerial and virtual projection of a digital image, in particular autostereoscopic image.

The invention also aims to provide, in at least one embodiment, a device for the aerial and virtual projection of a digital image, in particular autostereoscopic image, which allows a viewer to interact with the virtual image.

The invention also aims to provide, in at least one embodiment, a device for the aerial and virtual projection of a digital image, in particular autostereoscopic image, which can be used in all types of industry, especially in the fields of medicine, automobiles, aeronautics, railways, advertising, museums, education and training, etc.

The invention also aims to provide, in at least one embodiment, a closed device for the aerial and virtual projection of a digital image that allows the image to be seen without it being possible to access the device's components and without the multiple reflections caused by the presence of a window perpendicular to the main optical output axis.

### 4. DISCLOSURE OF THE INVENTION To achieve this, the invention relates to a device for the aerial and virtual projection of an autostereoscopic digital image, comprising:

a case comprising a front wall and a rear wall, connected to each other by at least an upper wall and a lower wall, said front wall comprising an opening that forms a viewing window for said projected digital autostereoscopic image,
an optical system comprising at least one concave spherical mirror with an optical axis, a focal length F, a center of radius of curvature C located on said optical axis, said optical system being arranged in said case such that it can direct at least part of the received incident light towards said viewing window to form a floating, virtual image of the digital image,
a display screen for autostereoscopic images with N viewpoints, overlaid with a cylindrical lens array forming an optical component for selecting viewpoints of said autostereoscopic digital image to be projected, housed in said case opposite said spherical mirror at a distance substantially equal to twice the focal length F, and distanced from said optical axis of said spherical mirror, perpendicularly to this optical axis, by a distance at least equal to half the height of the display screen, said height being defined according to the axis perpendicular to said optical axis.

A device according to the invention allows the virtual projection through a viewing window in a case of a digital image displayed on a display screen housed in the case. According to the invention, the display screen is offset in relation to the optical axis of the spherical mirror by a distance at least equal to half the height of the display screen, to prevent the image reflected by the spherical mirror from interacting with the original image displayed on the display screen. This image reflected by the spherical mirror can be seen by a viewer either directly, by positioning the viewing window opposite this returned image, in which case the image reflected by the spherical mirror forms the virtual image, or via one or more additional reflections by one or more mirrors, such as semi-reflective mirrors, and by positioning the viewing window opposite the image reflected by the last optical component on the optical path thus formed by the semi-reflective mirrors.

Since the display screen is housed in the case at a distance substantially equal to twice the focal length F of the spherical mirror, in the same position as the center of the concave mirror, the image projected at the viewing window is inverted at full scale. Since the image is projected at full scale, it retains the quality of the source image, without any magnification, which minimizes the geometric distortions of the conic perspective introduced by the optical projection system.

Depending on the type of image to be projected, the screen can advantageously be pivoted 180 degrees so that the projected image is the right way up for a viewer.

In addition, the display screen is a display screen for autostereoscopic images with N viewpoints, overlaid with a cylindrical lens array forming an optical component for selecting viewpoints of the image.

This aspect of the invention makes it possible to project aerial and floating three-dimensional images that pop out of the viewing window. Unlike projecting a three-dimensional image of a real object, which is affected by significant magnification of the conic perspective, the three-dimensional image remains equivalent to what would be perceived by direct vision without excessive magnification. In fact, although the three-dimensional effect is due to binocular vision, autostereoscopic images are flat and coplanar.

According to a first variant of the invention, said spherical mirror is arranged at the rear wall of the case, and said screen is arranged at said viewing window formed in said front wall of said case, in symmetry with said viewing window relative to the optical axis of said spherical mirror, so that the screen image reflected by said spherical mirror directly forms the floating and virtual image of the image at the viewing window. Although the image is virtual and floating, it is located in the viewing window.

According to a second variant of the invention, said spherical mirror is arranged at said upper wall of said case, said screen is arranged at said lower wall of said case, and said optical system further additionally comprises a tilted semi-reflective mirror arranged on the optical path linking said screen and said spherical mirror at the viewing window so that the image displayed by said screen, after transmission by the semi-reflective mirror, reflection on the spherical mirror and reflection on the semi-reflective mirror, appears virtual and floating to a viewer.

According to this variant, the semi-reflective or semi-transparent mirror advantageously has an anti-reflective rear surface and a partially reflective front surface to avoid a double-reflection effect on the two surfaces of the lens. Thus, although the semi-reflective mirror is transparent during transmission from behind, it reflects part of the radiation on the front surface. Therefore, by tilting the semi-transparent mirror at an angle of approximately 45° on the optical path between the display screen and the spherical mirror, part of the light from the screen's source image passes through the semi-transparent plane mirror without being deflected (part is reflected to the inside, being lost to the rear). It then strikes the surface of the spherical mirror, is reflected and bounces onto the reflective surface of the semi-transparent mirror and part of the light is thus diverted towards the viewing window to form the aerial and virtual image of the source image in front of the window. This image is the right way up if the screen is placed upside down in the case. The other part of the light rays passes through the semi-reflective mirror in a straight line, as if it did not exist, to form an image of the screen in symmetry with the screen, but upside down. Since the screen is offset in the direction perpendicular to the optical axis of the spherical mirror, this symmetrical image does not interact with the display screen, and the quality of the image is preserved.

This architecture for the device according to the second variant with the spherical mirror, the viewing window and the screen respectively arranged at the upper, front and lower walls, and with the presence of a semi-reflective mirror on the optical path, makes it possible to prevent light coming through the viewing window from the outside, after being reflected on the concave mirror, from disrupting the aerial image formed by the device. In fact, the presence of the semi-reflective mirror tilted at 45° on the optical path between the viewing window and the concave mirror ensures that only part of the radiation from outside reaches the concave mirror. This concave window also reflects this radiation, of which only part is in turn transmitted to the viewing window. In other words, the image of the environment reflected by the concave mirror, when the latter is arranged according to the architecture of this second variant, appears very dark at the viewing window and therefore does not disrupt the aerial and virtual image formed by the device.

According to a variant of the invention, the rear wall of the case is transparent or has an opening onto the outside such that a viewer can, by transparency, view real elements in the background or virtually displayed on a flat or autostereoscopic screen, in combination with the image popping out from the viewing window.

Advantageously and according to the invention, said spherical mirror is pivoted about said center of the radius of curvature C by a predetermined angle and said display screen is tilted relative to the spherical mirror, such that the normal in the center of the screen is perpendicular to the tangent plane of said spherical mirror. This compensates for the trapezoid effect of the projected image introduced by offsetting said display screen relative to the optical axis of the spherical mirror.

According to this aspect of the invention, the trapezoid effect introduced by offsetting the screen relative to the optical axis of the spherical mirror is compensated for by tilting the screen to ensure that it matches as well as possible the symmetrical curvature of the spherical mirror arranged opposite.

In practice, the display screen has a distal end corresponding to the bottom of the displayed image and located towards the rear wall of the case, and a proximal end corresponding to the top of the displayed image and located towards the front wall of the case. The screen is tilted so that said distal end of the display screen is raised relative to said proximal end so as to compensate for the trapezoid effect of the projected image introduced by offsetting said display screen relative to the optical axis of the spherical mirror.

In addition, the spherical mirror is pivoted about the center of the radius of curvature C by a predetermined angle. In other words, the mirror is moved forward towards the front wall of the case according to the plane of its curvature, which allows the image to be recentered relative to the viewing pupil and the viewing window. The viewing window consists of the opening formed on the front-facing side of the device, and the viewing pupil consists of the reflection from the concave mirror in the semi-transparent mirror at 45° perceived as if it were arranged vertically at the bottom of the device opposite the window. Although the pupil is behind and the aerial image in front, the image disappears as soon as a viewer's eye can no longer see the pupil behind the floating image. Thus, the mirror reflection acts as a viewing pupil. The larger the mirror with regard to its focal length, the easier viewing off the main axis becomes. It becomes possible to increase the distance from the central axis without the floating image disappearing. The difficulty lies in making a very open mirror, that is to say with a diameter as wide as possible and a focal length as short as possible.

Advantageously and according to the invention, the device comprises a pre-compensation device for distortions of the flat image displayed by said display screen such that the projected image, after reflection by said spherical mirror forming a convergent optical device, regains a geometry consistent with the original geometry of the autostereoscopic image.

The distortions are the spherical curvature of the image plane (which generally causes very few problems since the three-dimensional aspect of the displayed image enables it to be slightly corrected. An inverse curvature of the image plane is simulated to compensate for it). For other distortions in the x- and y-axes, the solution for the distortion of straight lines into a balloon shape as the distance from the concave mirror axis increases (the bottom of the image is relatively distorted whereas the top of the image is not), comes from image processing.

Advantageously and according to this aspect of the invention, with said projected image extending in a predetermined frame of reference on the x-, y- and z-axes, said compensation device is formed, in the direction of the z-axis, by said cylindrical lens array of said screen for displaying autostereoscopic images, wherein a pitch of said array has been reduced relative to the optimal pitch. This allows said autostereoscopic images to be viewed at a predetermined nominal distance in the absence of the spherical mirror.

The use of a screen for displaying an autostereoscopic image instead of a screen for displaying a flat image generates further difficulties due to the presence of the concave spherical mirror, which modifies the pitch ratio between the lens array and the screen pitch, and subjects the assembly to the laws of conic perspective. In fact, the pitch of a lens array is determined for an ideal viewing distance selected by determining the pitch of said array taking into account its focal length (distance from the optical centers of the micro-lenses to the screen surface) and of said screen pitch. Based on an ideal theoretical position for an eye positioned at the desired distance, rays are sent out which must pass through each optical center of the micro-lenses to aim at the points of the screen modulo N (N being the selected number of viewpoints). The effects of the conic perspective generated by the presence of the optical projection system modifies the transverse pitch of the lens array by slightly enlarging it relative to the screen pitch. Since the desired alignment is no longer possible, the assembly will produce a large number of moiré effects incompatible with the desired result. In order to correct the distortion of the transverse pitch of the lens array of the autostereoscopic device, a first solution is to deflect the light rays coming from the screen seen through the micro-lenses at the screen by means of an optical device refracting with the same focal length as the mirror, in order to return the parallel rays to infinity after the concave mirror (in this case, the lenses must be big enough to cover the entire screen surface and their focal length must be short enough to compensate for the effects of the mirror). In practice, it is difficult to achieve this with standard lenses because they would then be too thick to fit into a compact case. On the other hand, a set of Fresnel lenses could be combined to achieve this since they are very thin. This being so, the concentric lines of Fresnel lenses produce a moiré effect with the lines of the lenses in the autostereoscopic screen's lens array, and the smooth, reflective surfaces cause a large number of reflections in this fully optical device. Given the curvature of fields and the change in differential magnification between the array pitch and the screen pitch, this solution to form a pre-compensation device is therefore difficult to implement in practice, even if it makes it possible to compensate for the effects of conic perspective.

Another advantageous solution is to calculate a new pitch for the lens array applied to the autostereoscopic screen. Although the focal length of the lens array is very short (its distance to the screen is 1 mm on average), on account of being used for conic perspective, the differential magnification of the lens array and of the screen no longer matches. An accuracy of a tenth of a micron (or less) is usually required to adjust the distance of use of these screens. The calculations carried out to manufacture these optical components take into account the size of the screen sub-pixels, the focal length of the micro-lenses (distances from the optical centers to the screen surface), the ideal theoretical viewing distance, the number of viewpoints and the basic stereoscopic conditions chosen for the application.

In other words, according to this aspect of the invention, the pre-compensation device is formed by said cylindrical lens array of said screen for displaying autostereoscopic images, wherein the pitch is reduced relative to the optimal pitch, allowing said autostereoscopic images to be viewed at a predetermined nominal distance in the absence of the spherical mirror.

Advantageously and according to this aspect of the invention, with said projected image extending in a predetermined frame of reference on the x-, y- and z-axes, said digital image displayed on said autostereoscopic display screen is also pre-distorted to compensate for the geometric distortions in the x- and y-axes of the projected image linked to offsetting said display screen relative to the optical axis of said spherical mirror and to the presence of a concave spherical mirror forming an optical system subject to conic perspective rules.

This digital pre-distortion of the images combined with conic pre-compensation of the lens array makes it possible to obtain a projected image that regains its original 3D dimensions.

Advantageously and according to the invention, the device furthermore comprises at least one sensor for detecting and recognizing the viewer's movements which is mounted on said front or upper wall of said case in the vicinity of said viewing window and a processing unit connected to said sensor and/or said display screen such that the viewer's movements can control the display screen to modify the projected image, thus giving the viewer the illusion of manipulating said projected image, and/or can control the ancillary equipment connected to the processing unit, said aerial and virtual image thereby forming a control interface for this ancillary equipment.

According to this aspect of the invention, the device comprises a motion detection sensor calibrated to the screen so that the viewer's movements in front of this sensor give the feeling of interacting with the virtual image.

For example, in the case of projecting an autostereoscopic image, the motion detector can be configured so that the viewer rotates the projected image as if it were a real object, for example by successively displaying the different viewpoints of the image.

The motion detection and recognition sensor also allows the viewer, according to some embodiments, to control ancillary equipment connected to the processing unit. The projected aerial and virtual image thus forms a control interface for this ancillary equipment.

This aspect of the invention has multiple applications in many technical fields, including medicine, automobiles, aeronautics, museums, etc.

In fact, with a device according to this aspect of the invention it is possible to create a virtual interface for everything found in the cockpit of an airplane, the interior of a car, etc., and thus operate all the digital control equipment by interacting with the virtual three-dimensional image projected by the device according to the invention.

In a museum, visitors will be able to safely handle rare and valuable objects, and will be able to have fun, interactive and efficient access to large amounts of information.

In the field of luxury goods, it becomes possible to display very high-resolution images of valuable, rare or unique objects, and allow customers and people who are curious to discover all their qualities without taking any risks and optimize the illusion that the object is really present.

The pop-out effect produced by a device according to the invention, in the context of an autostereoscopic image, also makes it possible to present an object outside a display window, a few centimeters from the window, thus giving the feeling of being able to handle and interact with the object.

Advantageously and according to the invention, said display screen is configured to be able to display a sequence of digital images forming video content.

Advantageously and according to the invention, at least one digital image is an image intended for an application in medicine, automobiles, aeronautics, railways, advertising, etc.

Advantageously and according to the invention, the device further comprises an anti-reflective glass pane extending across said viewing window. Alternatively or in combination, this anti-reflective glass pane is configured to form a protective, anti-theft window, for example in the context of using a device according to the invention in a jewelry shop.

The invention also relates to a device for the aerial and virtual projection of a digital image, in particular autostereoscopic image, characterized in combination by all or some of the features mentioned above or below.

### 5. LIST OF FIGURES

Further aims, features and advantages of the invention will become apparent upon reading the following description, which is provided solely by way of a non-restrictive example, and which refers to the appended figures, in which:

FIG. 1 is a schematic cross-sectional view of a device according to a first embodiment of the invention,

FIG. 2 is a schematic cross-sectional view of a device according to a second embodiment of the invention.

### 6. DETAILED DESCRIPTION OF EMBODIMENTS OF THE INVENTION

For illustrative purposes and clarity, scales and proportions are not strictly adhered to in the figures.

In addition, identical, similar or analogous elements are denoted using the same references in all figures.

The embodiments described in connection with the figures relate to displaying an autostereoscopic image, it being understood that they may also be used to display a non-autostereoscopic digital image.

As shown in FIG. 1, the device comprises a case 10, for example an opaque case comprising a front wall 11 and a rear wall 12, connected to each other by an upper wall 13 and a lower wall 14, as well as side walls that are not visible in the cross-sectional view in FIG. 1.

In the following, the device is described as it is when the lower wall 14 extends in a horizontal plane. Also, in FIG. 1, the rear wall 12 extends vertically, indicated by the direction of gravity.

The front wall 11 comprises an opening forming a viewing window 15. This viewing window 15 is preferably formed of a tilted (approximately 80° relative to the horizontal) anti-reflective glass pane.

According to one embodiment not shown in the figures, the rear wall of the case can be transparent or have an opening onto the outside so that a viewer can, by transparency, view real elements in the background or displayed virtually on a flat or autostereoscopic screen, in combination with the image popping out from the viewing window.

The device according to the invention also comprises a screen 23 for displaying an autostereoscopic image to be projected. This screen 23 is a display screen for autostereoscopic images with N viewpoints, overlaid with a cylindrical lens array forming an optical component for selecting viewpoints of the image. This screen is for example an ALIOSCOPY® screen as described in patent FR2995713 under the name of the applicant. This screen can be mounted in the case by all types of means, gluing, screwing, mechanical locking, etc.

The device also comprises an optical system comprising a concave spherical mirror 24 with optical axis 20, focal length F, and center of radius of curvature C located on said optical axis 20. It also comprises a tilted semi-reflective mirror 22 arranged on the optical path linking said screen 23 and said spherical mirror 24 at the viewing window 15 so that the image 31 displayed by the screen 23, after transmission by the semi-reflective mirror 22, reflection on the spherical mirror 24 and reflection on the semi-reflective mirror 22, appears virtual and floating through the viewing window 15 to a viewer. The spherical mirror can be mounted in the case by all types of means, gluing, mechanical locking, etc.

According to the invention, the screen 23 is arranged opposite the spherical mirror 24 at a distance substantially equal to twice the focal length F of the spherical mirror 24, that is to say at a distance approximately twice the focal distance F.

In addition, the screen 23 is offset relative to the optical axis 20, perpendicularly to this optical axis 20, by a distance at least equal to the half the height H/2 of the display screen, said height H being defined according to the axis perpendicular to said optical axis.

According to one embodiment of the invention, the screen is a screen with a height of 14 cm, which is therefore offset 7 cm perpendicularly to the optical axis of the spherical mirror 24.

In addition, the spherical mirror 24 is pivoted about the center of the radius of curvature C by a predetermined angle and the display screen 23 is tilted relative to the spherical mirror so that the normal in the center of the screen is perpendicular to the tangent plane of the spherical mirror 24, so as to compensate for a trapezoid effect of the projected image introduced by offsetting the display screen 23 relative to the optical axis 20 of the spherical mirror.

This pivoting of the spherical mirror results, for example, in the spherical mirror 24 being moved forward towards the front wall 11 of the case 10 along the mirror's plane of curvature. For example, a mirror with a focal length of 30 cm is moved forward 7 cm.

According to the embodiment in FIG. 1, the angle of the semi-reflective mirror differs slightly from 45 degrees to ensure that the aerial and virtual image is vertical. A person skilled in the art can easily carry out the adjustment tests to obtain the desired effect depending on the optical devices used.

According to the embodiment in FIG. 1, the device comprises a pre-compensation device for the distortions of the flat image displayed by the display screen 23, such that the projected image, after reflection by the spherical mirror 24, regains a geometry consistent with the original geometry of the autostereoscopic image.

Considering a frame of reference on the x-, y- and z-axes at the projected image, the pre-compensation device comprises for example an image processing module to compensate for the distortions in the x- and y-axes.

The pre-compensation device for the z axis is formed by the cylindrical lens array of the display screen 23, in which a pitch of the array has been reduced relative to the optimal pitch, allowing the autostereoscopic images to be viewed at a predetermined nominal distance in the absence of the spherical mirror.

In other words, the cylindrical lens array of the screen 23 has a reduced pitch relative to the optimal pitch, allowing the autostereoscopic images to be viewed at a predetermined nominal distance in the absence of the spherical mirror. For example, considering a screen to be used at 80 cm, and a spherical mirror with a focal length of 30 cm, the lens array should ideally match the lens array that would have been required to view at 20 cm.

In FIG. 1, the source image displayed by the screen 23 is schematically represented by reference 31. The virtual image projected outside the case 10 is schematically represented by reference 32. The returned image of the source image 31 is schematically represented by reference 33.

The dashed lines represent the light ray paths from the source image 31 to the plane of the aerial and virtual image 32. The dotted lines represent the paths of the light rays forming the returned image 33. Thus, considering the ray 41 emitted by one end of the source image 31, it first passes through the semi-reflective mirror 22 by its non-reflective rear surface. The ray is reflected by the spherical mirror 24. Part of this light ray is then reflected by the semi-transparent mirror 22 to form the ray 41a towards the viewing window 15 to form the aerial and virtual image 32. The part of the non-reflected light ray passes through the semi-reflective mirror 22 to form the ray 41b which forms the returned image 33.

The rays emitted by the other end of the source image 31 and shown in FIG. 1 are derived from the center of the radius of curvature of the spherical mirror, such that the part of the radiation forming the returned image coincides with the direction of radiation emitted from the source image.

The device according to the embodiment in the figures also comprises a sensor 40 for detecting and recognizing the viewer's movements, which sensor is mounted on the front wall 11 of said case 10 under the viewing window 15.

This sensor is for example a Leap Motion® sensor configured to detect hand movements or a moving object in front of the sensor. This sensor is connected to a processing unit and the display sensor 23 so as to interact with the image. This interaction with the image detected by the sensor and interpreted by the processing unit can, for example, be used to control all types of equipment, for example equipment in a car, aircraft cockpit, medical operating room, and connected to the processing unit by all types of means. Thus, depending on which areas of the aerial and virtual image that the viewer touches virtually, the equipment can be actuated, controlled or can react according to the previously made settings. The sensor may also be connected to the screen 23 so that interactions with the virtual image consist of modifying the image display, for example to rotate it in all desired directions.

FIG. 2 represents another embodiment according to the invention. According to this embodiment, the optical system comprises only a concave spherical mirror and a display screen. The spherical mirror is arranged at the rear wall of the case, and the screen is arranged at the front wall of the case, in symmetry to the viewing window relative to the optical axis of said spherical mirror.

Thus, according to this embodiment, a viewer directly views the returned image of the source image through the viewing window. This returned image corresponds to 100% of the light reflected by the spherical mirror since, unlike in the embodiment in FIG. 1, there is no semi-reflective mirror deflecting part of the light. In addition, right/left symmetry is applied to the displayed images, as when viewing by a single plane mirror.

Like the embodiment in FIG. 1, the screen is tilted relative to the spherical mirror so that the normal in the center of the screen is perpendicular to the tangent plane of the spherical mirror 24, so as to compensate for a trapezoid effect of the projected image introduced by offsetting the display screen 23 relative to the optical axis of the spherical mirror.

A device according to the invention is not limited only to the embodiments described and illustrated in the figures. In particular, according to other embodiments, the optical system may comprise other optical elements arranged relative to each other such that the virtual aerial image can be brought to a viewing window arranged elsewhere in the case.

A device according to the invention can also be used with a real object even if its main purpose is to be adapted to digital images, especially to autostereoscopic images.

1. A device for the aerial and virtual projection of an autostereoscopic digital image comprising:
a case comprising a front wall, a rear wall, connected to each other by at least an upper wall and a lower wall, said front wall comprising an opening forming a viewing window for an aerial and virtual image of said digital autostereoscopic image,
an optical system comprising at least one concave spherical mirror having an optical axis, a focal length, a center of the radius of curvature located on said optical axis, said optical system being arranged in said case such that it can direct at least part of the received incident light towards said viewing window to form an aerial and virtual image of the digital autostereoscopic image,
a screen for displaying autostereoscopic images with N viewpoints, overlaid with a cylindrical lens array forming an optical component for selecting viewpoints of said digital autostereoscopic image to be projected, housed in said case opposite said spherical mirror at a distance substantially equal to twice the focal length, and distanced from said optical axis of said spherical mirror, perpendicularly to this optical axis by a distance of at least half the height of the display screen, said height being defined according to the axis perpendicular to said optical axis.

2. The device according to claim 1, characterized in that said spherical mirror is pivoted about said center of the radius of curvature G by a predetermined angle and in that said display screen is tilted relative to the spherical mirror such that the normal in the center of the screen is perpendicular to the tangent plane of said spherical mirror, so as to compensate for a trapezoid effect of the projected image introduced by offsetting said display screen relative to the optical axis of the spherical mirror.

3. The device according to claim 1, characterized in that the device comprises at least one sensor for detecting and recognizing the viewer's movements, which sensor is mounted on said front wall or upper wall of said case in the vicinity of said viewing window, and a processing unit connected to said sensor and/or said display screen so that the viewer's movements can control the display screen to modify the projected image, thus giving the viewer the illusion of manipulating said projected image, and/or can control ancillary equipment connected to the processing unit, said aerial and virtual image (32) thereby forming a control interface for this ancillary equipment.

4. The device according to claim 1, characterized in that said spherical mirror is arranged at the rear wall of the case, and in that said screen is arranged at said viewing window formed in said front wall of said case, in symmetry with said viewing window relative to the optical axis of said spherical mirror, such that the image of the screen reflected by said spherical mirror directly forms the floating and virtual image of the image through the viewing window.

5. The device according to claim 1, characterized in that said spherical mirror is arranged at said upper wall of said case, said screen is arranged at said lower wall of said case, and in that said optical system further comprises a tilted semi-reflective mirror arranged on the optical path linking said screen and said spherical mirror at the viewing window, such that the image displayed by said screen, after transmission by the semi-reflective mirror, reflection on the spherical mirror and reflection on the semi-reflective mirror, appears virtual and floating through the viewing window to a viewer.

6. The device according to claim 1, characterized in that said opening in said front wall extends in a plane forming an angle of approximately 80 degrees relative to the axis of the optical output path of the image projected from the case.

7. The device according to claim 1, characterized in that it further comprises an anti-reflective glass pane extending across said viewing window.

8. The device according to claim 1, characterized in that it further comprises a pre-compensation device for distortions of the image displayed by said display screen, such that the projected image, after reflection by said spherical mirror forming a convergent optical device, regains a geometry consistent with the original geometry of the autostereoscopic image.

9. The device according to claim 8, characterized in that, said projected image extending in a predetermined frame of reference on the x-, y- and z-axes, said pre-compensation device is formed, in the z-axis direction, by said cylindrical lens array of said screen for displaying autostereoscopic images in which a pitch of said array has been reduced relative to the optimal pitch, allowing said autostereoscopic images to be viewed at a predetermined nominal distance in the absence of the spherical mirror.

10. The device according to claim 8, characterized in that, said projected image extending in a predetermined frame of reference on the x-, y- and z-axes, said autostereoscopic digital image displayed on said display screen is digitally pre-distorted to compensate for the geometric distortions of the projected image along the x- and y-axes linked to offsetting said display screen relative to the optical axis of said spherical mirror and to the presence of a concave spherical mirror forming a convergent optical system subject to conic perspective rules.

11. The device according to claim 1, characterized in that said display screen is configured to be able to display a sequence of digital images forming video content.
